(19) United States
(12) Patent Application Publication
(10) Pub. No.: US 2016/0036045 A1
(43) Pub. Date: Feb. 4, 2016

(54) ANODES FOR LITHIUM-ION DEVICES

(71) Applicant: StoreDot Ltd., Herzeliya (IL)

(72) Inventors: Doron BURSHTAIN, Herzeliya (IL); Liron AMIR, Ramat Gan (IL); Daniel ARONOV, Netanya (IL); Olga GUCHOK, Ramat Gan (IL); Leonid KRASOVITSKY, Rishon LeTzion (IL)

(21) Appl. No.: 14/813,499

(22) Filed: Jul. 30, 2015

Related U.S. Application Data
(60) Provisional application No. 62/030,622, filed on Jul. 30, 2014.

(51) Int. Cl. H01M 4/36; H01M 4/38; H01G 11/30; H01G 11/36; H01G 11/52; H01G 11/56; H01M 4/587; H01M 10/0525

(52) U.S. Cl. CPC H01M 4/364; H01M 4/587; H01M 4/386; H01M 4/38; H01M 10/0525; H01G 11/36; H01G 11/52; H01G 11/56; H01G 11/30; H01M 2004/027

(57) ABSTRACT

An anode material for a lithium ion device includes an active material including silicon and boron. The weight percentage of the silicon is between about 4 to 35 weight % of the total weight of the anode material and the weight percentage of the boron is between about 2 to 20 weight % of the total weight of the anode material. The active material may include carbon at a weight percentage of between between 5 to about 60 weight % of the total weight of the anode material. Additional materials, methods of making and devices are taught.

### CROSS REFERENCE TO RELATED APPLICATIONS

This application claims the benefit of U.S. Provisional Application Ser. No. 62/030,622, filed on Jul. 30, 2014 and entitled “Compounds for Battery Electrodes, Energy-Storage Devices, and Methods therein”, which is incorporated in its entirety herein by reference.

### TECHNICAL FIELD

The present disclosure relates to electrode active materials used in lithium ion devices, such as rechargeable lithium ion batteries.

### BACKGROUND OF THE INVENTION

Lithium ion batteries, also known as Li-ion Batteries or LIB's are widely used in consumer electronics, for example in mobile telephones, tablets and laptops. LIB's are also used in other fields, such as military uses, electric vehicles and aerospace applications. During discharge of the battery, lithium ions (Li ions) travel from a high-energy anode material through an electrolyte and a separator to a low-energy cathode material. During charging, energy is used to transfer the Li ions back to the high-energy anode assembly. The charge and discharge processes in batteries are slow processes, and can degrade the chemical compounds inside the battery over time. Rapid charging causes accelerated degradation of the battery constituents, as well as a potential fire hazard due to a localized, over-potential build-up and increased heat generation—which can ignite the internal components, and lead to explosion.

Typical Li-ion Battery anodes contain mostly graphite. Silicon, as an anode-alloying component, generally exhibits higher lithium absorption capacities in comparison to anodes containing only graphite. Such silicon-containing electrodes, however, usually exhibit poor life cycle and poor Coulombic efficiency due to the mechanical expansion of silicon upon alloying with lithium, and upon lithium extraction from the alloy, which reduce the silicon alloy volume. Such mechanical instability results in the material breaking into fragments.

### SUMMARY OF THE INVENTION

Some embodiments of the invention may be directed to lithium-ion devices and in particular to anodes for lithium-ion devices. An anode material for a lithium ion device according to some embodiments of the invention may include an active material including silicon and boron. In some embodiments, the weight percentage of the silicon may be between about 4 to 35 weight % of the total weight of the anode material and the weight percentage of the boron may be between about 2 to 20 weight % of the total weight of the anode material. In some embodiments, the weight percentage of the silicon may be between about 5 to about 25 weight % of the total weight of the anode material and the weight percentage of the boron may be between about 5 to about 18 weight % of the total weight of the anode material.

An active material for producing anodes for Li-ion devices may include silicon at a weight percentage of about between 5 to 47 weight % of the total weight of the active material and boron at a weight percentage of about between 3 to 25 weight % of the total weight of the active material. In some embodiments, the active material may include carbon. In some embodiments, the active material may further include tungsten at a weight percentage of between about 6 to about 25 weight % tungsten of the total weight of the active material.

Some embodiments of the invention may be directed to a lithium ion device. The lithium ion device may include an anode having an active material comprising silicon and boron. In some embodiments, the weight percentage of the silicon may be between about 4 to 35 weight % of the total weight of the anode and the weight percentage of the boron may be between about 2 to 20 weight % of the total weight of the anode. The lithium ion device may further include a cathode and an electrolyte.

Some embodiments of the invention may be directed to a method for making an anode material for a lithium ion device. The method may include forming an alloy from silicon powder, carbon, and a boron-containing compound to form an active material, and adding the active material to a matrix to form the anode material. In some embodiments, the weight percentage of the silicon is between about 4 to about 35 weight % of the total weight of the anode material and the weight percentage of the boron is between about 2 to about 20 weight % of the total weight of the anode material.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of an exemplary lithium ion device according to some embodiments of the invention;

FIG. 2 is a graph presenting first-cycle charge-discharge curves of an exemplary lithium-ion half-cell for a silicon-based anode containing boron according to some embodiments of the invention;

FIG. 3 is a graph presenting first-cycle charge-discharge curves of an exemplary lithium-ion half-cell for a silicon-based anode containing tungsten according to some embodiments of the invention; and

FIG. 4 is a graph presenting initial cycles, charge-discharge curves of an exemplary lithium-ion half-cell for a silicon-based anode containing boron and tungsten according to some embodiments of the invention; and

FIG. 5 is a graph presenting first-cycle charge-discharge curves of an exemplary lithium-ion half-cell for a silicon-based anode.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the invention describe anodes for lithium ion devices, an active material (anode intercalation compounds) for manufacturing the anodes and the lithium ion devices. The term active material refers herein to an alloying material that is chemically active with lithium ions. The lithium ion devices may include lithium ion batteries (Li-ion battery or LIB), Li-ion capacitors (LIC), Li-ion hybrid system including both a battery and a capacitor or the like.

The active material may include an alloy comprising graphite (C), silicon (Si) and boron (B). The carbon, silicon and boron may be milled together to form an alloy. Other methods for forming alloys may be used. In some embodiments, the active material may further include tungsten (W) in the form of tungsten carbide (WC) particles. In some embodiments, the active material may include an alloy comprising graphite (C), silicon (Si) and tungsten (W).

According to embodiments of the invention, the composition of the anode may comprise an active anode material as detailed herein, a binder and/or plasticizer (e.g. polyvinylidene fluoride (PVDF)) and a conductive agent (e.g. carbon black and carbon nano-tubes (CNT)).

According to some embodiments, the weight percentage of the silicon may be between about 4 to 35 weight % of the total weight of the anode material and the weight percentage of the boron may be between about 2 to 20 weight % of the total weight of the anode material. According to other embodiments, the weight percentage of the silicon may be between about 4 to 35 weight % of the total weight of the anode material and the weight percentage of the tungsten may be between about 2 to 20 weight % of the total weight of the anode material. In some embodiments, the weight percentage of the silicon may be between about 5 to 25 weight % of the total weight of the anode material, the weight percentage of the boron may be between about 5 to 18 weight % of the total weight of the anode material. The weight percentage of the carbon (in the form of graphite) within the active material may be between about 5 to 60 weight % of the total weight of the anode material, for example, between 7 to 48 weight %.

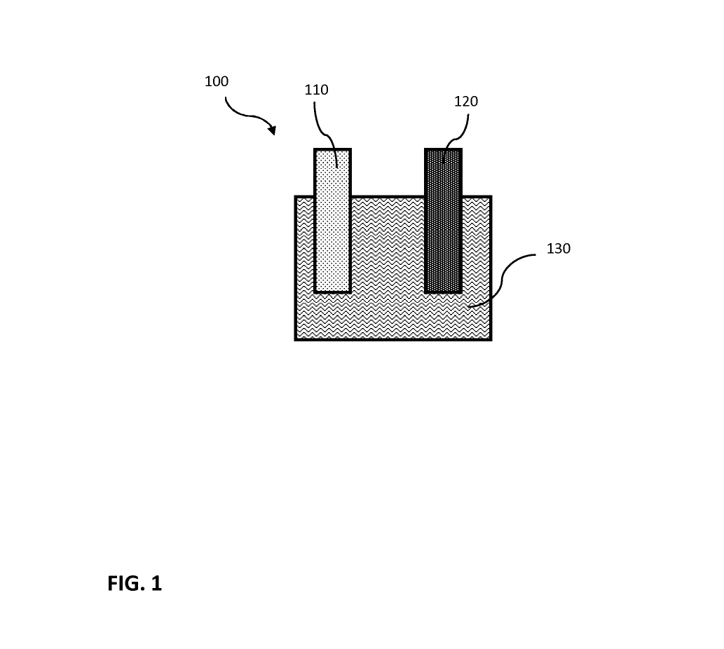

Reference is made to FIG. 1, illustrating an exemplary lithium ion device according to some embodiments of the invention. A lithium ion device 100 may include an anode 110 as detailed herein, a cathode 120 and an electrolyte 130 suitable for lithium ion devices. A non-limiting list of exemplary lithium ion devices may be Li-ion batteries, Li-ion capacitors and Li-ion hybrid system including both a battery and a capacitor. Electrolyte 130 may be in the form of a liquid, solid or gel. Examples of solid electrolytes include polymeric electrolytes such as polyethylene oxide, fluorine-containing polymers and copolymers (e.g., polytetrafluoroethylene), and combinations thereof. Examples of liquid electrolytes include ethylene carbonate, diethyl carbonate, propylene carbonate, fluoroethylene carbonate (FEC), and combinations thereof. The electrolyte may be provided with a lithium electrolyte salt. Examples of suitable salts include LiPF₆, LiBF₄, lithium bis(oxalato)borate, LiN(CF₃SO₂)₂, LiN(C₂F₅SO₂)₂, LiAsF₆, LiC(CF₃SO₂)₃, LiClO₄, and LiTFSI. Cathode 120 may include cathode compositions suitable for the use in lithium ion devices. Examples of suitable cathode compositions may include LiCoO₂, LiCo_{0.33}Mn_{0.33}Ni_{0.33}O₂, LiMn₂O₄, and LiFePO₄.

In some embodiments, lithium ion device 100 may further include a separator (not illustrated). The separator may be configured to separate between the anode and the cathode. An exemplary separator according to some embodiments of the invention may include poly ethylene (PE), polypropylene (PP) or the like.

Anode 110 according to embodiments of the invention, when incorporated in a lithium ion device, such as battery, exhibits improved cycle-life and Coulombic efficiency over common Si-based anodes. The mechanical stability of the anode (achieved after the first cycle, or after several initial cycles), and hence of the lithium ion device, is also improved. Such stability is assumed to be attributed to the incorporation of the tungsten and/or boron into the expanding silicon-lithium alloy during the charge-discharge process. Such incorporation may help preventing metallization of the lithium during charging due to the relatively strong lithium-tungsten and/or lithium-boron binding. Such strong binding may result in a partly-charged assembly which may contribute to the enhanced stability and cycle life of the anode.

The presence of boron and/or tungsten may facilitate the electrochemical utilization of the silicon, and substantially may reduce the migration of silicon into the electrode substrate. Moreover, boron carbide may enhance the binding energy of Li atoms, (boron's binding energy is greater than the cohesive energy of lithium metal) and may prevent lithium from clustering at high lithium doping concentrations.

Boron carbide, which is inert to oxidation at the anode in the electrochemical reaction, interacts with both silicon, silicon oxide and lithium. Lithium ions may react with boron carbide to form lithium carbide, lithium boride and lithium tetraborate thus leaving the Li ions partly charged. Such partial charges in Li-Si-C alloys may stabilize the overall structure during the extraction and insertion of the lithium ions.

Tungsten carbide with naturally-occurring silicon oxide-carbon composites may improve the electrochemical behavior of the anode. The tungsten-carbide may act as hydron (H⁺) ion barrier and further as a δ⁺ center inside the Si/C structure. The δ⁺ centers may capture the Li ions to further prevent metallization of Li.

Preparation of the anode may include milling and/or mixing processes. In some embodiments, a silicon powder and graphite powder may be inserted into a high-energy ball-miller to be milled under protective atmosphere or non-protective atmosphere. In some embodiments, a boron-carbide (B₄C) powder may be added to the pre-milled Si/C mixture inside the miller The miller may include hardened alumina media that may be agitated at 1000-1500 RPM. The milling stage may produce an alloy having nano-size particles of around 20-100 nm particle size. In some embodiments, an emulsion containing nano-sized tungsten carbide (WC) particles may be added to the as milled powder (Si/C or SI/CB alloy) at the end of the milling process to produce the active material for the anode. The tungsten carbide particle size may be between around 20 to 60 nm As used herein, “nano-sized” particles means particles having an average particle size less than one micron, in embodiments “nano-sized” means particles having an average particle size less than 100 nm

The active material for making anodes for Li-ions devices (e.g., device 100), such as batteries may include a silicon-carbon-boron-tungsten alloy, a silicon-carbon-boron alloy or a silicon-carbon-tungsten alloy. Additional polymeric binders and conductive additives may be added to the alloy to form the final anode material. An exemplary anode, according to embodiments of the invention, may include conductive materials at a weight percentage of about between 5 to 10 weight % of the total weight of the anode material and binder material at a weight percentage of about between 5 to 10 weight % of the total weight of the anode material. Exemplary conductive elements may include spherical carbon, carbon nano-tubes and/or graphene particles.

In some embodiments, the active material may include a silicon-carbon-boron alloy, in which the weight percentage of the silicon may be between about 5 to about 47 weight % of the total weight of the active material, the weight percentage of the boron may be between about 3 to about 25 weight % of the total weight of the active material and the weight percentage of the carbon may be between about 7 to about 75 weight % of the total weight of the active material. In some embodiments, weight percentage of the carbon may be between about 10 to about 60 weight % of the total weight of the active material.

In some embodiments, the active material may include a silicon-carbon-boron-tungsten alloy, in which the weight percentage of the silicon may be between about 5 to about 47 weight % of the total weight of the active material, the weight percentage of the boron may be between about 3 to about 25 weight % of the total weight of the active material, the weight percentage of the carbon may be between about 7 to about 75 weight % of the total weight of the active material and the weight percentage of the tungsten may be between about 6 to 25 weight % of the total weight of the active material. In some embodiments, weight percentage of the carbon may be between about 10 to 60 weight % of the total weight of the active material.

In some embodiments, the active material may include a silicon-carbon-tungsten alloy, in which the weight percentage of the silicon may be between about 5 to about 47 weight % of the total weight of the active material, the weight percentage of the carbon may be between about 7 to about 75 weight % of the total weight of the active material and the weight percentage of the tungsten may be between about 6 to about 25 weight % of the total weight of the active material.

In some embodiments, the anode material may further include carbon nano-tubes (CNT) at a weight percentage of about between 0.05 to 0.5 weight % of the total weight of the anode. The carbon nano-tubes may replace the tungsten carbide particles or be added to the anode material in addition to the tungsten carbide particles. Accordingly, the alloy material may include between 0.06-0.8 weight % carbon nano-tubes of the total weight of the anode material. An exemplary anode material may include 0.1-0.3 weight % single-rod carbon nano-tubes.

### EXAMPLES

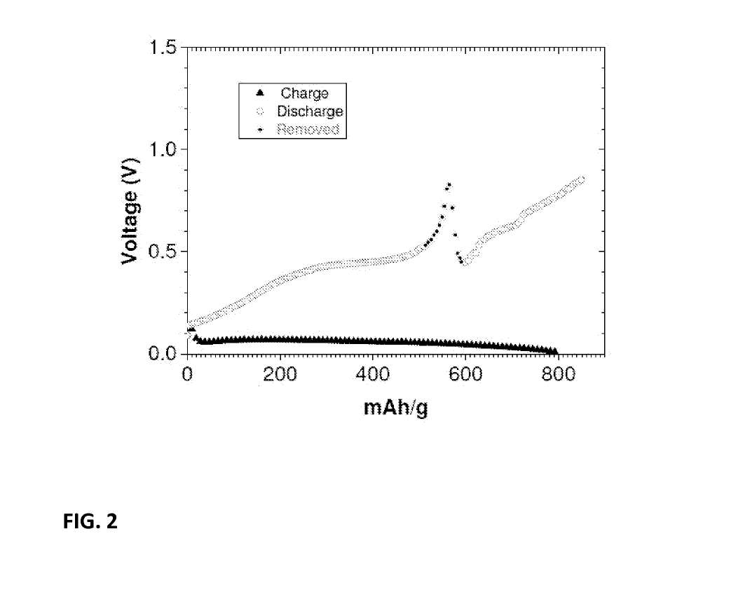

Reference is made to FIG. 2 presenting first-cycle charge-discharge curves of an exemplary lithium-ion half-cell for a silicon-based anode containing boron according to some embodiments of the invention. The voltage of the half-cell is presented as a function of the charge values in mAh/g. The exemplary anode material included (in weight percentage from the total weight of the anode) 48% C, 30% Si, 5.5% B, 8.3% binder and 8.2% conductive additives (C_{0.48}Si_{0.30}B _{0.55}Binder_{0.083}ConductiveAditive_{0.082}). The as-milled C/Si/B alloy (i.e. the active material) included 57% C, 36% Si and 7% B weight percent of the total weight of the alloy (C_{0.57}Si_{0.36}B_{0.07}). Looking at the graphs of FIG. 2, the charge yielded 792 mAh/g, and the discharge produced 760 mAh/g, resulting in a 96% first-cycle efficiency. The first-cycle efficiency is defined as the first discharge yield divided by the first charge yield. It is noted that within the discharge curve, there is a region in which the current is positive but the potential difference drops. Such “inverse behavior” is probably due to an internal self-reorganization; therefore, this region was removed from the charge-discharge calculation.

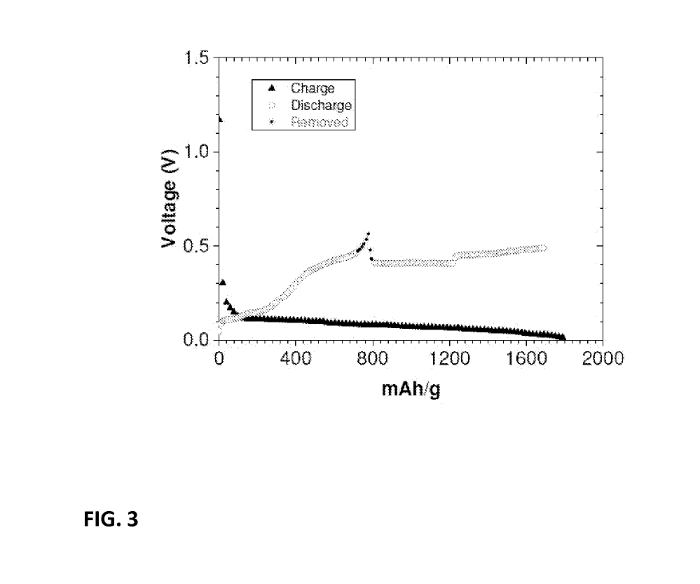

Reference is made to FIG. 3, presenting first-cycle charge-discharge curves of an exemplary lithium-ion half-cell for a silicon-based anode containing tungsten according to some embodiments of the invention. The voltage of the half-cell is presented as a function of the charge values in mAh/g. The exemplary anode material included 41.3% C, 30.1% Si, 11.6% W, 8.4% binder and 8.6% conductive additives (C_{0.413}Si_{0.301}W_{0.116}Binder_{0.084}ConductiveAditive_{0.086}) in weight percentage of the total weight of the anode. The active material included 50% C, 36% Si and 14%W in weight percentage of the total weight of the alloy (C_{0.50}Si_{0.36}W_{0.14}). Looking at the graph of FIG. 3, the charge yielded 1803 mAh/g, and the discharge produced 1600 mAh/g, resulting in 88.7% first-cycle efficiency. It is noted again, as in FIG. 2, that within the discharge curve, there is a region in which the current is positive but the potential difference drops. Such “inverse behavior” is probably due to an internal self-reorganization; therefore, this region was removed from the charge-discharge calculation. For the same amount of Si (30%), the B addition yielded a higher efficiency than the W addition.

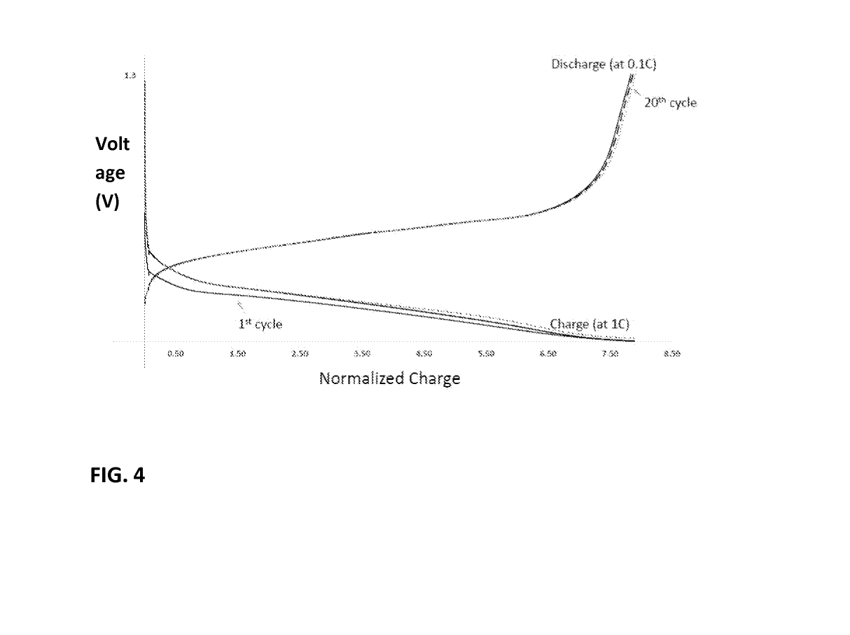

According to some embodiments, both boron and tungsten are part of the anode. FIG. 4 presents a graph showing the charge-discharge curves of the first 20 cycles of an exemplary Lithium-ion half-cell for a silicon-based anode containing boron and tungsten according to some embodiments of the invention. The voltage of the half-cell is presented as a function of the normalized charge (normalized by the highest value). The exemplary anode material included 42% C, 30% Si, 5.0% B, 10.0% W, 10% binder and 3% conductive additives (C_{0.42}Si_{0.3}B_{0.05}W_{0.1}Binder_{0.1}ConductiveAditive_{0.03}) in weight percentage of the total weight of the anode. The active material included 48.3% C, 34.5% Si, 5.7% B and 10.5% W in weight percentage of the total weight of the alloy (C_{0.483}Si_{0.345}B_{0.057}W_{0.105}). The calculated first-cycle efficiency was 92% however, the life-cycle efficiency was 98.5-100%.

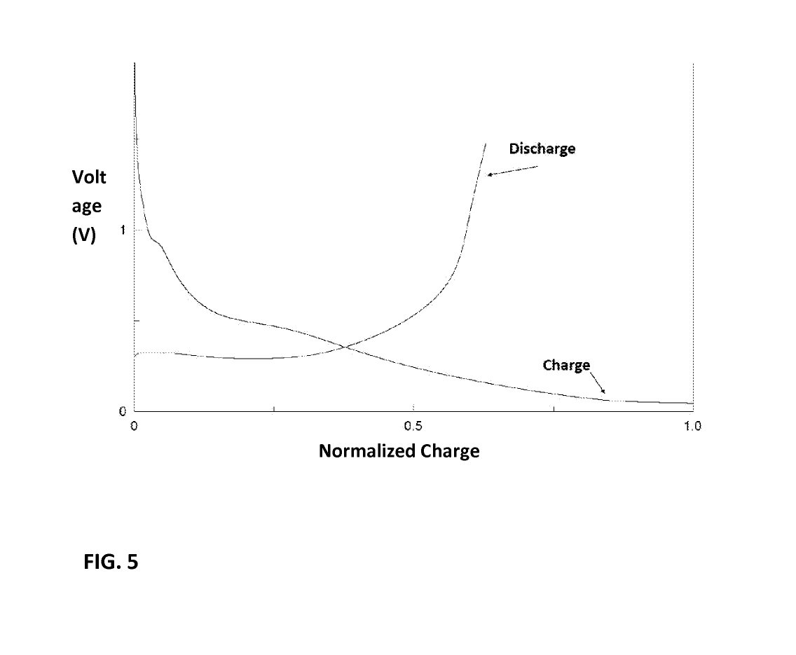

Reference is made to FIG. 5 presenting first-cycle charge-discharge curves of an exemplary lithium-ion half-cell for a silicon-based anode containing silicon and carbon. The voltage of the half-cell is presented as a function of the normalized charge (normalized by the highest value).The exemplary anode material included 57% C, 30% Si, 10% binder and 3% conductive additives (C_{0.57}Si_{0.3}Binder_{0.1}ConductiveAditive_{0.03}) in weight percentage of the total weight of the anode. The active material included 66% C and 34% Si in weight percentage of the total weight of the alloy (C_{0.66}Si_{0.34}). Looking at the graph of FIG. 5 the calculated first efficiency was approximately 65% much lower than the anodes of the examples of FIGS. 2-4.While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An anode material for a lithium ion device, comprising:
an active material comprising silicon and boron, wherein the weight percentage of the silicon is between about 4 to about 35 weight % of the total weight of the anode material and the weight percentage of the boron is between about 2 to about 20 weight % of the total weight of the anode material.

2. The anode material of claim 1, wherein the active material further comprises carbon at a weight percentage of about between 5 to about 60 weight % of the total weight of the anode material.

3. The anode material of claim 1, wherein the active material further comprises tungsten at a weight percentage of between about 5 to about 20 weight % of the total weight of the anode material.

4. The anode material of claim 1, further comprising:
carbon nano-tubes (CNT) at a weight percentage of between about 0.05 to about 0.5 weight % of the total weight of the anode material.

5. The anode material of claim 1, wherein the weight percentage of the silicon is between about 5 to about 25 weight % of the total weight of the anode material and the weight percentage of the boron is between about 5 to about 18 weight % of the total weight of the anode material.

6. The anode material of claim 1, wherein the active material further comprises tungsten at a weight percentage of between about 7 to about 13 weight % of the total weight of the anode material.

7. The anode material of claim 1, further comprising:
one or more conductive materials, wherein and the weight percentage of the conductive materials is between about 0.01 to about 15 weight % of the total weight of the anode material.

8. The anode material of claim 7, wherein the conductive materials comprise at least one of spherical carbon particles, carbon-nano-tubes and graphene particles.

9. The anode material of claim 1, further comprising:
a binder at a weight percentage of between about 0.1 to about 10 weight % of the total weight of the anode material

10. An active material for a producing anode for lithium ion devices, the active material, comprising:
silicon at a weight percentage of between 5 to about 47 weight % of the total weight of the active material; and
boron at a weight percentage of between about 3 to about 25 weight % of the total weight of the active material.

11. The active material of claim 10, further comprising tungsten at a weight percentage of between about 6 to about 25 weight % tungsten of the total weight of the active material.

12. A lithium ion device comprising:
an anode having an active material comprising silicon and boron, wherein the weight percentage of the silicon is between about 4 to about 35 weight % of the total weight of the anode and the weight percentage of the boron is between about 2 to about 20 weight % of the total weight of the anode;
a cathode; and
an electrolyte.

13. The lithium ion device of claim 12, wherein the active material further comprises carbon at a weight percentage of about between 5 to about 60 weight % of the total weight of the anode.

14. The lithium ion device of claim 12, wherein the active material further comprises tungsten at a weight percentage of about between 5 to about 20 weight % of the total weight of the anode.

15. The lithium ion device of claim 11, wherein the anode further comprises:
carbon nano-tubes (CNT) at a weight percentage of about between 0.05 to 0.5 weight % of the total weight of the anode.

16. The lithium ion device of claim 12, wherein the anode further comprises:
one or more conductive materials, the weight percentage of the conductive materials is between about 0.01 to about 15 weight % of the total weight of the anode.

17. The lithium ion device of claim 12, wherein the device is a battery.

18. The lithium ion device of claim 12, wherein the device is a capacitor.

19. The lithium ion device of claim 12, further comprising a separator between the anode and the cathode.

20. The lithium ion device of claim 12, comprising a solid electrolyte.

21. A method for making an anode material for a lithium ion device, comprising:
forming an alloy from silicon powder, carbon, and a boron-containing compound to form an active material, and adding the active material to a matrix to form the anode material;
wherein the weight percentage of the silicon is between about 4 to about 35 weight % of the total weight of the anode material and the weight percentage of the boron is between about 2 to about 20 weight % of the total weight of the anode material.

22. The method of claim 21, wherein the active material comprises carbon at a weight percentage of between about 5 to about 60 weight % of the total weight of the anode material.

23. The method of claim 21, wherein the active material further comprises tungsten at a weight percentage of between about 5 to about 20 weight % of the total weight of the anode material.

24. The method of claim 21, wherein the active material further comprises:
carbon nano-tubes (CNT) at a weight percentage of between about 0.05 to about 0.5 weight % of the total weight of the anode material.

25. The method of claim 21, wherein the weight percentage of the silicon is between about 5 to about 25 weight % of the total weight of the anode material and the weight percentage of the boron is between about 5 to about 18 weight % of the total weight of the anode material.

26. The method of claim 21, wherein the active material further comprises tungsten at a weight percentage of between about 7 to about 13 weight % of the total weight of the anode material.

27. The method of claim 21, wherein the anode material further comprises one or more conductive materials, and wherein the weight percentage of the conductive materials is between about 0.01 to about 15 weight % of the total weight of the anode material.

28. The method of claim 21, wherein the active material is milled to a particle size of about 20 to 100 nm.
